(19) United States
(12) Patent Application Publication
(10) Pub. No.: US 2026/0359121 A1
(43) Pub. Date: Nov. 12, 2026

(54) artificial intelligence accelerating device and method supporting various precisions

(71) Applicant: MEDIATEK INC., Hsinchu City (TW)

(72) Inventors: Nien-En Lee, San Jose, CA (US); Tsung-Han Lin, San Jose, CA (US)

(73) Assignee: MEDIATEK INC., Hsinchu City (TW)

(21) Appl. No.: 19/201,869

(22) Filed: May 7, 2025

(51) Int. Cl. G06F 9/50; G06F 12/02

(52) U.S. Cl. CPC G06F 9/5027; G06F 9/5072; G06F 12/0207

(57) ABSTRACT

An artificial intelligence (AI) accelerating system includes an AI accelerator for combining m input channels into m/Q input channels and combining n output channels into n/Q output channels when performing a Q×K-bit MAC operation in one cycle, an AI computing multiply and accumulation (MAC) unit for performing the Q×K-bit MAC operation in one cycle to generate an operation result, and a memory for storing the operation result, where K, Q, m, n are positive integers, and Q>1.

### BACKGROUND

In parallel computer architectures, a systolic array is a homogeneous network of tightly coupled data processing units (DPUs) called cells or nodes. Each node or cell in a systolic array independently computes a partial result based on data received from its upstream neighbors. The computed result is stored within the node itself and then passed downstream. Systolic arrays were initially used in Colossus, an early computer employed during World War II to break German Lorenz ciphers. Independently invented or rediscovered by H. T. Kung and Charles Leiserson, systolic arrays found applications in dense linear algebra computations (e.g., matrix product, solving linear equations, lower-upper (LU) decomposition) for banded matrices. Early applications also included computing greatest common divisors of integers and polynomials.

Systolic arrays are sometimes classified as multiple-instruction single-data (MISD) architectures under Flynn's taxonomy. However, this classification is debatable because systolic arrays exhibit distinct characteristics that set them apart from Flynn's traditional categories (SISD, SIMD, MISD, MIMD). The parallel input data flows through a network of hard-wired processor nodes. These nodes combine, process, merge, or sort the input data to derive a final result. The term ‘systolic’ was coined due to the wave-like propagation of data through the array, resembling the pulse of the human circulatory system. The name of systolic array is derived from ‘systole’, analogous to the regular pumping of blood by the heart.

In summary, systolic arrays play a crucial role in parallel processing, especially for tasks like integration, convolution, correlation, matrix multiplication, and data sorting. Their unique characteristics make them distinct from other architectural categories.

FIG. 1 is a conventional computing method 100 for an 8-bit multiplier built from a 4-bit multiplier according to an embodiment of the prior art. In a 4-bit multiplier, 0111(7)×1010(10) can be computed by adding 0000, 01110, 000000, and 0111000, thus generating the multiplied result 1000110(70). When the 4-bit multiplier is used to generate an 8-bit multiplier and the 8-bit multiplied result, the 4-bit multiplier is used several times. The 8-bit multiplier built from 4-bit multiplier 104 is shown in FIG. 1. 01110101(117)×10100101(165) can be computed by using 4-bit multiplier 4 times and adding the results together. A first 4-bit multiplied result (0101(5)×0101(5)) is 0101+00000+010100+000000=11001(25). A second 4-bit multiplied result (01110000(112)×0101(5)) is 01110000+000000000+0111000000+00000000000=1000110000(560). A third 4-bit multiplied result (0101(5)×10100000(160)) is 00000000+010100000+0000000000+01010000000=01100100000(800). A fourth 4-bit multiplied result (01110000(112)×10100000(160)) is 000000000000+0111000000000+00000000000000+011100000000000=100011000000000(17920). The 8-bit multiplied result can be generated by adding the four 4-bit multiplied result together 11001 (25)+1000110000 (560)+01100100000 (800)+100011000000000 (17920)=100101101101001(19305). This 8-bit multiplier 104 can be performed with four cycles using the 4-bit multiplier 102. In addition, 16-bit multiplier can be performed using 4-bit multiplier for 4×4=16 cycles. However, in some computing architecture such as systolic arrays, the computing result should be calculated in one cycle. Therefore, an AI accelerating system and method calculating in one cycle for various precisions is desired.

### SUMMARY

An embodiment provides an artificial intelligence (AI) accelerating system. The system includes an AI accelerator, an AI computing multiply and accumulation (MAC) unit, and a memory. The AI accelerator is used to combine m×n K-bit multiply and accumulation (MAC) into (m/Q)×(n/Q) Q×K-bit MAC when performing a Q×K-bit MAC operation in one cycle. The AI computing MAC unit is used to perform the Q×K-bit MAC operation in one cycle to generate an operation result. The memory is used to store the operation result. K, Q, m, n are positive integers, and Q>1.

An embodiment provides an AI accelerating method. The method includes an AI accelerator combining m input channels into m/Q input channels and combining n output channels into n/Q output channels when performing a Q×K-bit MAC operation in one cycle, an AI computing MAC unit performing the Q×K-bit MAC operation in one cycle to generate an operation result, and a memory storing the operation result. K, Q, m, n are positive integers, and Q>1.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a conventional computing method for an 8-bit multiplier built from a 4-bit multiplier according to an embodiment of the prior art.

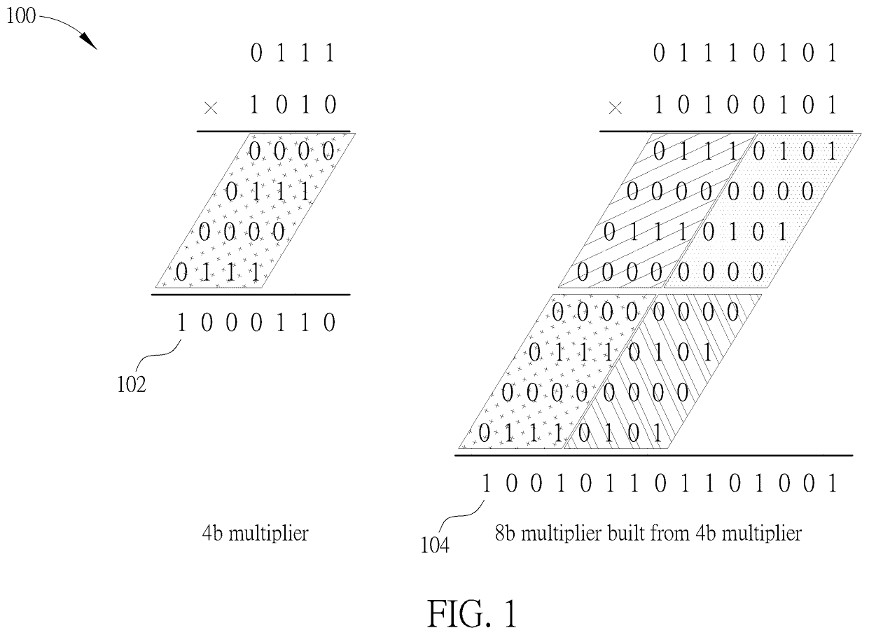

FIG. 2 is a matrix multiplier for machine learning model operation.

FIG. 3 is an 8-bit AI computing multiply-accumulate (MAC) unit using one cycle according to an embodiment of the present invention.

FIG. 4 is a block diagram of the artificial intelligence (AI) accelerating system according to an embodiment of the present invention.

FIG. 5 is a flowchart of the AI accelerating method according to an embodiment of the present invention.

### DETAILED DESCRIPTION

In artificial intelligence (AI) computing, particularly in digital signal processing (DSP), the multiply-accumulate (MAC) operation is a fundamental step that involves computing the product of two numbers and adding that product to an accumulator. The MAC operation modifies an accumulator (denoted as a) and add the product of two input values (b and c) to the accumulatora=a+b×.

When the MAC operation is performed with floating-point numbers, there are two common approaches such as two rounding approach and single rounding approach. In many DSPs, the MAC operation is performed with two rounding approach. In this case, single rounding approach is called a fused multiply-add (FMA) or fused multiply-accumulate (FMAC). The entire expression a=a+b×c is computed to full precision before rounding the final result down to a specified number of significant bits. IEEE® 754-2008 specifies that FMAs should be performed with a single rounding, resulting in a more accurate result.

Modern computers often include a dedicated MAC unit. The MAC unit includes a multiplier implemented in combinational logic. The MAC unit is followed by an adder and an accumulator register that stores the result. The output of the register is fed back to one input of the adder. On each clock cycle, the output of the multiplier is added to the register. Combinational multipliers require substantial logic but can compute products more efficiently than earlier methods (such as shifting and adding).

In summary, the MAC operation plays a crucial role in various mathematical computations, including dot products, matrix multiplications, and polynomial evaluations. Its efficient implementation significantly impacts performance in DSP and general-purpose computing. In the AI accelerator application, MAC operation is the key operation when performing convolutions in convolutional neural networks (CNNs) and activations in deep neural networks (DNNs).

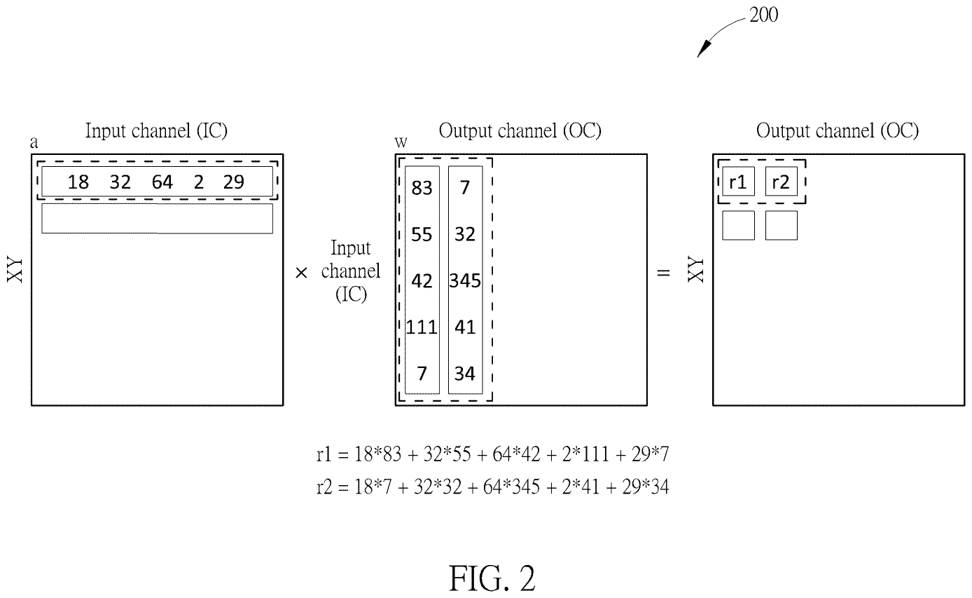

FIG. 2 is a matrix multiplier 200 for machine learning model operation. The input channel (IC) contains 5 columns of input data, and the output channel (OC) contains 2 columns of weightings. The input data contain 18, 32, 64, 2, 29, and the weightings contain 83, 55, 42, 111, 7, 7, 32, 345, 41, 34. The matrix multiplied result contains number r1 and number r2. Number r1 is 18×83+32×55+64×42+2×111+29×7=6367, and number r2 is 18×7+32×32+64×345+2×41+29×34=24298. This matrix multiply operation is commonly used in machine learning models, and the number of output channels determine the number of output results of the machine learning model. The number of input channels determines the number of input data of the machine learning model. In FIG. 2, the number of input channels is 5 and the number of output channels is 2. Therefore, the matrix multiply operation can be performed as shown in FIG. 2 to generate number r1 and number r2.

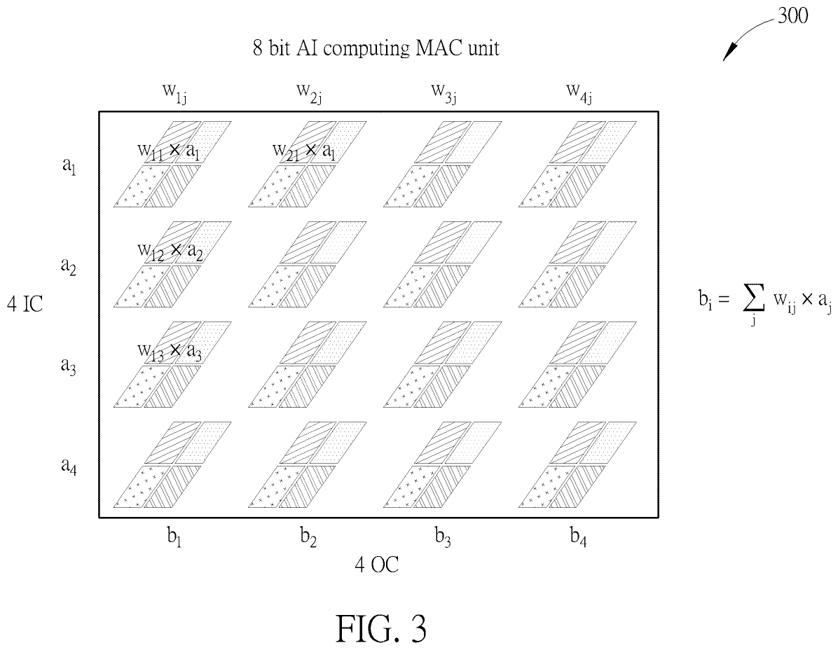

FIG. 3 is an 8-bit AI computing multiply-accumulate (MAC) unit 300 using one cycle according to an embodiment of the present invention. In FIG. 3, the matrix operation can be expressed by:

$${b}_{i} = {\sum }_{j} {w}_{ij} \times {a}_{j}$$

where bᵢ is the output data, wᵢⱼ is the weightings of the machine learning model, and aⱼ is the input data.

The number of input channels is 4, and the number of output channels is 4. In a common usage, the 8-bit AI compute MAC unit can perform 8-bit MAC operation and output the results as bᵢ. The output b₁ is calculated as b₁=w₁₁×a₁+w₁₂×a₂+w₁₃×a₃+w₁₄×a₄, the output b₂ is calculated as b₂=w₂₁×a₁+w₂₂×a₂+w₂₃×a₃+w₂₄×a₄, the output b₃ is calculated as b₃=w₃₁×a₁+w₃₂×a₂+w₃₃×a₃+w₃₄×a₄, and the output b₄ is calculated as b₄=w₄₁×a₁+w₄₂×a₂+w₄₃×a₃+w₄₄×a₄. The output results bᵢ are calculated by using input data aᵢ and the weightings wᵢⱼ of the machine learning model.

When the 8-bit AI compute MAC unit performs 16-bit MAC operation, the number of input channels is set as 2, and the number of output channels is set as 2. To fulfill the operation of 16-bit MAC, the input channels and output channels are sacrificed, and 4 (2×2) 8-bit AI compute elements are combined to calculate 1 16-bit AI compute element. The 16-bit MAC operation can thus be performed in one cycle by using 4 times 8-bit AI compute elements. The 16-bit output cᵢ is calculated as (1=w₁₁×a₁+w₁₂×a₂+w₁₃×a₃+w₁₄×a₄+w₂₁×a₁+w₂₂×a₂+w₂₃×a₃+w₂₄×a₄, and the 16-bit output c₂ is calculated as c₂=w₃₁×a₁+w₃₂×a₂+w₃₃×a₃+w₃₄×a₄+w₄₁×a₁+w₄₂×a₂+w₄₃×a₃+w₄₄×a₄. The output results cᵢ are calculated by using input data aᵢ and the weightings wᵢⱼ of the machine learning model. The 8-bit and 16-bit are only for example. In an embodiment, the MAC operation can be K-bit, and the Q×K-bit MAC operation can be performed in one cycle, where K and Q are positive integers.

In an embodiment, the 4-bit AI compute MAC unit can perform 4-bit MAC operation and output the results as bᵢ. The number of input channels is 6, and the number of output channels is 6. The output b₁ is calculated as b₁=w₁₁×1+w₁₂×a₂+w₁₃×a₃+w₁₄×a₄+w₁₅×a₅+w₁₆×a₆, the output b₂ is calculated as b₂=w₂₁×a₁+w₂₂×a₂+w₂₃×a₃+w₂₄×a₄+w₂₅×a₅+w₂₆×a₆, the output b₃ is calculated as b₃=w₃₁×a₁+w₃₂×a₂+w₃₃×a₃+w₃₄×a₄+w₃₅×a₅+w₃₆×a₆, the output b₄ is calculated as b₄=w₄₁×a₁+w₄₂×a₂+w₄₃×a₃+w₄₄×a₄+w₄₅×a₅+w₄₆×a₆, the output b₅ is calculated as b₅=w₅₁×a₁+w₅₂×a₂+w₅₃×a₃+w₅₄×a₄+w₅₅×a₅+w₅₆×a₆, and the output be is calculated as b₆=w₆₁×a₁+w₆₂×a₂+w₆₃×a₃+w₆₄×a₄+w₆₅×a₅+w₆₆×a₆. The output results bᵢ are calculated by using input data aᵢ and the weightings wᵢⱼ of the machine learning model.

When the 4-bit AI compute MAC unit performs 12-bit MAC operation, the number of input channels is set as 2, and the number of output channels is set as 2. To fulfill the operation of 12-bit MAC, the input channels and output channels are sacrificed, and 9 (3×3) 4-bit AI compute elements are combined to calculate 1 12-bit AI compute element. The 12-bit MAC operation can thus be performed in one cycle by using 9 times 4-bit AI compute elements. The 12-bit output c₁ is calculated as c₁=w₁₁×a₁+w₁₂×a₂+w₁₃×a₃+w₁₄×a₄+w₁₅×a₅+w₁₆×a₆+w₂₁×a₁+w₂₂×a₂+w₂₃×a₃+w₂₄×4+w₂₅×a₅+w₂₆×a₆+w₃₁×a₁+w₃₂×a₂+w₃₃×a₃+w₃₄×a₄+w₃₅×a₅+w₃₆×a₆, and the 16-bit output c₂ is calculated as c₂=w₄₁×a₁+w₄₂×a₂+w₄₃×a₃+w₄₄×a₄+w₄₅×a₅+w₄₆×a₆+w₅₁×a₁+w₅₂×a₂+w₅₃×a₃+w₅₄×a₄+w₅₅×a₅+w₅₆×a₆+w₆₁×a₁+w₆₂×a₂+w₆₃×a₃+w₆₄×a₄+w₆₅×a₅+w₆₆×a₆. The output results cᵢ are calculated by using input data aᵢ and the weightings wᵢⱼ of the machine learning model. The 4-bit and 12-bit are only for example. In an embodiment, the MAC operation can be K-bit, and the Q×K-bit MAC operation can be performed in one cycle, where K and Q are positive integers.

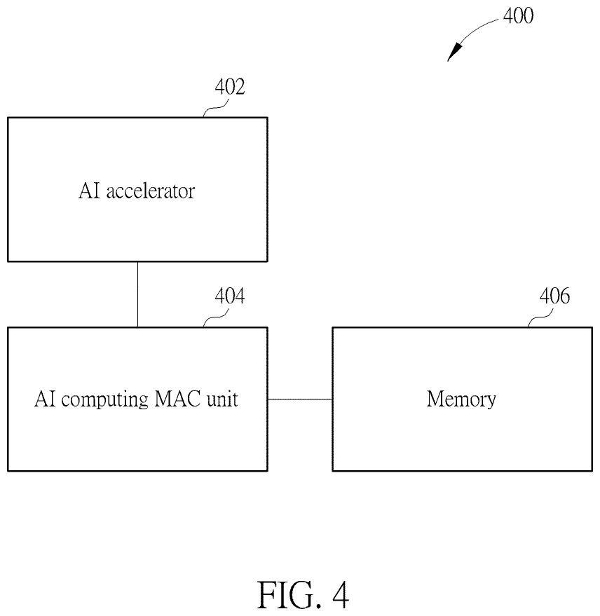

FIG. 4 is a block diagram of the artificial intelligence (AI) accelerating system 400 according to an embodiment of the present invention. The AI accelerating system 400 includes an AI accelerator 402, an AI computing MAC unit 404, and a memory 406. The AI accelerator 402 is used to combine m×n K-bit multiply and accumulation (MAC) into (m/Q)×(n/Q) Q×K-bit MAC when performing a Q×K-bit MAC operation in one cycle. In an embodiment, K, m, and n are positive integers, and Q is a common factor of m and n. In another embodiment according to FIG. 3, K is 8, mis 4, n is 4, and Q is 2. The number of input channels is 4 and the number of output channels is 4. The AI accelerator 402 combines the 4 input channels into 2 input channels, and the 4 output channels into 2 output channels, thus the 8-bit AI computing MAC unit 404 can perform 16-bit AI computing MAC operation in one cycle. The AI computing MAC unit 404 is used to perform the Q×K-bit MAC operation in one cycle to generate an operation result. In another embodiment, K is 4, m is 6, n is 6, and Q is 3. The number of input channels is 6 and the number of output channels is 6. The AI accelerator 402 combines the 6 input channels into 2 input channels, and the 6 output channels into 2 output channels, thus the 4-bit AI computing MAC unit 404 can perform 12-bit AI computing MAC operation in one cycle. The AI computing MAC unit 404 is used to perform the Q×K-bit MAC operation in one cycle to generate an operation result. The memory 406 is used to store the operation result.

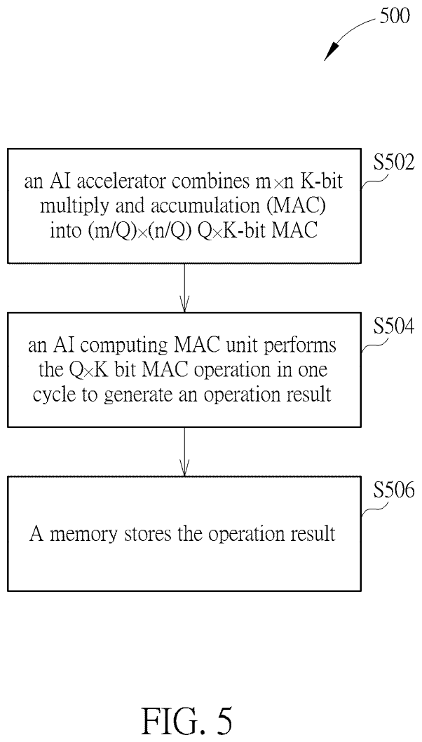

FIG. 5 is a flowchart of the AI accelerating method 500 according to an embodiment of the present invention. The method 500 includes the following steps:
Step S502: the AI accelerator 402 combines m×n K-bit multiply and accumulation (MAC) into (m/Q)×(n/Q) Q×K-bit MAC when performing a Q×K-bit MAC operation in one cycle;
Step S504: the AI computing MAC unit 404 performs the Q×K-bit MAC operation in one cycle to generate an operation result; and
Step S506: the memory 406 stores the operation result.

In step S502, the AI accelerator 402 combines m×n K-bit multiply and accumulation (MAC) into (m/Q)×(n/Q) Q×K-bit MAC when performing a Q×K-bit MAC operation in one cycle. In an embodiment, K, m, and n are positive integers, and Q is a common factor of m and n. In another embodiment according to FIG. 3, K is 8, m is 4, n is 4, and Q is 2. The number of input channels is 4 and the number of output channels is 4. The AI accelerator 402 combines the 4 input channels into 2 input channels, and the 4 output channels into 2 output channels, thus the 8-bit AI computing MAC unit 404 can perform 16-bit AI computing MAC operation in one cycle. In another embodiment, K is 4, m is 6, n is 6, and Q is 3. The number of input channels is 6 and the number of output channels is 6. The AI accelerator 402 combines the 6 input channels into 2 input channels, and the 6 output channels into 2 output channels, thus the 4-bit AI computing MAC unit 404 can perform 12-bit AI computing MAC operation in one cycle. In step S504, the AI computing MAC unit 404 performs the Q×K-bit MAC operation in one cycle to generate an operation result. In step S506, the memory 406 stores the operation result.

In conclusion, the Q×K-bit MAC operation can be performed in one cycle using K-bit AI computing MAC unit by combining m input channels and n output channels into m/Q input channels and n/Q output channels. In embodiment according to FIG. 3, the number of input channels is 4, and the number of output channels is 4. K is 8, and Q is 2. The 8-bit AI computing MAC unit 300 performs 16-bit AI computing MAC operation using combined 2 input channels and combined 2 output channels. Therefore, the present invention can be applied in machine learning applications with various precisions using only one cycle.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An artificial intelligence (AI) accelerating system, comprising:
an AI accelerator, comprising an m×n K-bit multiply and accumulation (MAC) array and a switch;
an AI computing MAC unit, coupled to the AI accelerator, and configured to perform a Q×K-bit MAC operation in one cycle to generate an operation result; and
a memory, coupled to the AI computing MAC unit, and configured to store the operation result;
wherein the switch is configured to switch the m×n K-bit MAC array to an (m/Q)×(n/Q) Q×K-bit MAC array when the AI computing MAC unit performs the Q×K-bit MAC operation in one cycle; and
wherein K, Q, m, n are positive integers, and Q>1.

2. The system of claim 1, wherein the AI computing MAC unit has m/Q input channels and n/Q output channels.

3. The system of claim 1, wherein the AI accelerator is further configured to sum matrix products to generate an output datum of the operation result, and each of the matrix products is generated from input data in Q input channels and weightings in Q output channels.

4. The system of claim 1, wherein K=2^{j}, and j is a positive integer.

5. The system of claim 1, wherein Q is a common factor of m and n.

6. An artificial intelligence (AI) accelerating method, comprising:
an AI accelerator combining m×n K-bit multiply and accumulation (MAC) into (m/Q)×(n/Q) Q×K-bit MAC when performing a Q×K-bit MAC operation in one cycle;
an AI computing MAC unit performing the Q×K-bit MAC operation in one cycle to generate an operation result; and
a memory storing the operation result;
wherein K, Q, m, n are positive integers, and Q>1.

7. The method of claim 6, wherein the AI computing MAC unit has m/Q input channels and n/Q output channels.

8. The method of claim 6, further comprising:
the AI computing MAC unit generating each of matrix products from input data in Q input channels and weightings in Q output channels; and
the AI accelerator summing the matrix products to generate an output datum of the operation result.

9. The method of claim 6, wherein K=2^{j}, and j is a positive integer.

10. The method of claim 6, wherein Q is a common factor of m and n.
